(19) United States
(12) Patent Application Publication
(10) Pub. No.: US 2026/0161427 A1
(43) Pub. Date: Jun. 11, 2026

(54) INTEGRATED TILE SPECIFICATION STORAGE

(71) Applicant: Capital One Services, LLC, McLean, VA (US)

(72) Inventors: Christopher DELIA, New Market, MD (US); Dominique BERTON, McLean, VA (US); Amit SHARMA, Vienna, VA (US); Devendra NATEKAR, Vienna, VA (US)

(21) Appl. No.: 19/205,384

(22) Filed: May 12, 2025

Related U.S. Application Data
(60) Provisional application No. 63/728,487, filed on Dec. 5, 2024.
(60) Provisional application No. 63/728,476, filed on Dec. 5, 2024.
(60) Provisional application No. 63/728,494, filed on Dec. 5, 2024.

(51) Int. Cl. G06F 9/451; G06F 8/38

(52) U.S. Cl. CPC G06F 9/451; G06F 8/38

(57) ABSTRACT

In some implementations, a system may store one or more unhydrated tile specifications for one or more dynamic user experiences. The system may store content information that is insertable into one or more blank fields of the one or more unhydrated tile specifications. The system may receive, from a device, a request that indicates a dynamic user experience from the one or more dynamic user experiences. The system may obtain, based on the dynamic user experience, an unhydrated tile specification, from the one or more unhydrated tile specifications, and one or more content data objects from the content information. The system may automatically generate a hydrated tile specification based on the unhydrated tile specification and the one or more content data objects. The system may transmit, to the device, the hydrated tile specification to cause the device to render and display the dynamic user experience via a user interface.

### CROSS-REFERENCE TO RELATED APPLICATIONS

This Patent Application claims priority to U.S. Provisional Ser. No. 63/728,487, filed on Dec. 5, 2024, and entitled “CAPABILITY NEGOTIATION FOR DYNAMIC USER INTERFACE TILES,” to U.S. Provisional Ser. No. 63/728,476, filed on Dec. 5, 2024, and entitled “EXPERIENCE CONFIGURATION FOR DYNAMIC USER INTERFACE TILES,” and to U.S. Provisional Ser. No. 63/728,494, filed on Dec. 5, 2024, and entitled “RESOLVING AND HYDRATING DYNAMIC TILE SPECIFICATIONS.” The disclosures of the prior Applications are considered part of and are incorporated by reference into this Patent Application.

### BACKGROUND

A graphical user interface is a form of user interface that allows users to interact with electronic devices. A web browser or application executing on a client device may provide a graphical user interface that presents one or more pages. A user may navigate to a page by entering a web address into an address bar of the web browser and/or by clicking a link displayed via another page. Navigation to a page may consume resources of a client device on which the web browser is installed or the application is executing, may consume resources of a server that serves the page to the client device, and/or may consume network resources used for communications between the client device and the server.

### SUMMARY

Some implementations described herein relate to a system for integrated tile specification storage. The system may include a storage component and a tile provider component configured to communicate with the storage component via an interface. The storage component may be configured to store one or more unhydrated tile specifications for one or more dynamic user experiences. The storage component may be configured to store one or more content key-value pairs that indicate data that is insertable into one or more blank fields of the one or more unhydrated tile specifications. The tile provider component may be configured to receive, from a device, a request that indicates a dynamic user experience from the one or more dynamic user experiences. The tile provider component may be configured to obtain, from the storage component and via the interface, an unhydrated tile specification from the one or more unhydrated tile specifications based on the dynamic user experience. The tile provider component may be configured to obtain, from the storage component and via the interface, at least one content key-value pair from the one or more content key-value pairs based on the request. The tile provider component may be configured to automatically generate a hydrated tile specification based on the unhydrated tile specification and the at least one content key-value pair, wherein the hydrated tile specification can be rendered by the device. The tile provider component may be configured to transmit, to the device, the hydrated tile specification to cause the device to render and display the dynamic user experience via a user interface.

Some implementations described herein relate to a method for integrated tile specification storage. The method may include storing, by a system, one or more unhydrated tile specifications for one or more dynamic user experiences. The method may include storing, by the system, content information that is insertable into one or more blank fields of the one or more unhydrated tile specifications. The method may include receiving, by the system and from a device, a request that indicates a dynamic user experience from the one or more dynamic user experiences. The method may include obtaining, by the system and based on the dynamic user experience, an unhydrated tile specification, from the one or more unhydrated tile specifications, and one or more content data objects from the content information. The method may include automatically generating, by the system, a hydrated tile specification based on the unhydrated tile specification and the one or more content data objects. The method may include transmitting, by the system and to the device, the hydrated tile specification to cause the device to render and display the dynamic user experience via a user interface.

Some implementations described herein relate to a system. The system may include one or more memories and one or more processors coupled to the one or more memories. The one or more processors may be configured to store one or more unhydrated tile specifications for one or more dynamic user experiences. The one or more processors may be configured to store content information that is insertable into one or more blank fields of the one or more unhydrated tile specifications. The one or more processors may be configured to receive, from a device, a request that indicates a dynamic user experience from the one or more dynamic user experiences. The one or more processors may be configured to obtain, based on the dynamic user experience, an unhydrated tile specification, from the one or more unhydrated tile specifications, and one or more content data objects from the content information. The one or more processors may be configured to automatically generate a hydrated tile specification based on the unhydrated tile specification and the one or more content data objects. The one or more processors may be configured to transmit, to the device, the hydrated tile specification to cause the device to render and display the dynamic user experience via a user interface.

### BRIEF DESCRIPTION OF THE DRAWINGS

FIGS. 1A-1C are diagrams of an example associated with integrated tile specification storage, in accordance with some embodiments of the present disclosure.

FIG. 2 is a diagram of an example associated with integrated tile specification storage, in accordance with some embodiments of the present disclosure.

FIG. 3 is a diagram of an example associated with a tile specification for dynamic user interface tiles, in accordance with some embodiments of the present disclosure.

FIG. 4 is a diagram of an example associated with a tile provider system for dynamic user interface tiles, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of a device associated with tile specification generation for dynamic user interface tiles, in accordance with some embodiments of the present disclosure.

FIG. 7 is a flowchart of an example process associated with integrated tile specification storage, in accordance with some embodiments of the present disclosure.

### DETAILED DESCRIPTION

The following detailed description of example implementations refers to the accompanying drawings. The same reference numbers in different drawings may identify the same or similar elements.

A user interface of a client device may include a page for presentation via the client device. The user interface may include one or more graphical elements (e.g., for a graphical user interface (GUI)) that are configured to enable a user to interact with the client device (e.g., rather than using text-based commands or other commands). The graphical element(s) may include icons, visual indicators, buttons, menus, windows, text, interactive components, links, and/or visual elements, among other examples. The graphical elements may enable different user experiences to be provided for display to the user via the GUI. As used herein, “user experience” refers to a manner and/or design in which information is presented to a user via one or more graphical elements of a GUI. A user experience may include a design (e.g., a size, a shape, and/or content being displayed) and/or layout of one or more graphical elements. A user experience may be evaluated based on one or more factors, such as usability, accessibility, visual design, responsiveness, and/or ease of navigation, among other examples. For example, a user experience may be designed to make the GUI intuitive, efficient, and/or enjoyable for a user to accomplish a goal. Therefore, improved user experiences for a GUI may reduce the amount of navigation performed by the user via the client device to accomplish the goal, thereby conserving processing resources, network resources, and/or power resources, among other examples, that would have otherwise been associated with additional navigation via the client device. Further, improved user experiences for a GUI may make data easier to access by enhancing the GUI, thereby enhancing user-friendliness of the client device and the GUI, and improving the ability of the user to use the client device, among other examples.

In some cases, a user experience may be changed or redesigned over time (e.g., to improve the performance and/or effectiveness of the user experience). However, the user experience may be provided via multiple channels that use respective interfaces (e.g., GUIs or other interfaces) to provide the user experience for display (e.g., where each channel is configured for a specific platform while maintaining the design and interactions of the user experience). For example, the multiple channels may include one or more applications (e.g., a web application or a mobile application), a web page, and/or a program (e.g., executing on the client device), among other examples. Additionally, a given channel may be associated with multiple variations or types. For example, a mobile application may be deployed via multiple operating systems that have different design conventions, use different formats, have application programming interface (API) details, and/or support different hardware, among other examples.

Therefore, it may be difficult to maintain consistency when updating or changing a user experience across multiple channels because of the channel-specific (or operating system-specific) differences. For example, it may be difficult to maintain a uniform design and functionality across various platforms (e.g., web, mobile, and/or desktop) that may have different user interface guidelines, technical limitations, and/or performance characteristics. Additionally, when deploying updates for mobile applications, the process may be more complex due to the different requirements of different operating systems. Further, an application may be associated with different versions. Different users may be using different versions of the application, introducing additional complexity associated with deploying the updated user experience across different versions of the same application (e.g., where the different versions may support different features). Additionally, ensuring synchronization of features, performance, and/or updates across all channels without introducing inconsistencies or bugs can be a time-consuming and resource-intensive process. As a result, updating a user experience may consume significant processing resources and/or time associated with designing, configuring, deploying, and/or testing the user experience separately for each channel (and/or for each operating system for a given channel).

In some examples, an update to a user experience may be deployed by deploying updated code for the GUI, such as by updating hypertext markup language (HTML) code. This may include updating the HTML structure for a GUI, such as a layout, content, and/or markup, among other examples. However, in such examples, the updated code may be deployed at a server device and provided to a client device when the client device requests a given user experience. As a result, the user experience (e.g., configured or deployed using the updated code) may not have the same look and feel as the rest of the GUI because the updated code may not use native components of the client device.

In some implementations described herein, a system may provide user experiences in an omni-channel manner using a specification (e.g., referred to herein as a “tile specification” or a “dynamic tile definition”). The tile specification may define a user interface component using a specification language (e.g., a dynamic tile language in JavaScript object notation (JSON)). The system (e.g., one or more server devices) may transmit, and a client device may receive, the tile specification. The client device may render a tile based on the tile specification and use one or more native components to display a tile via a GUI. As used herein, “tile” or “user interface tile” refers to a graphical element that represents an application, function, and/or piece of content, among other examples, within a digital interface, such as a GUI. A tile may be “dynamic” in that the design of the tile, the content presented or displayed via the tile, a function of the tile, and/or a link presented or displayed via the tile, among other examples, may vary over time (e.g., depending on a user experience requested, attributes of the user and/or client device, and/or other factors).

By the system using the tile specification to define the manner in which a user experience is to be displayed via a user interface, the system can dynamically update the user experience by changing information in the tile specification. This enables the system to quickly and easily deploy updates for the user experience because a client device may be configured to obtain the tile specification, extract information from the tile specification, and render the tile using native components to generate the tile for the GUI to be displayed by the client device. This ensures that the tile will be generated in accordance with requirements and/or formats of a given channel because the tile is rendered at the client device (e.g., and is not deployed and/or configured using more complex updates and/or schemes).

In some examples, a tile specification may be stored in an unhydrated state, which may be referred to herein as an “unhydrated tile specification.” “Unhydrated” refers to the tile specification including one or more fields or information elements that are blank or unfilled, where the one or more fields or information elements are configured for dynamic data to be inserted at, or near, the time when a dynamic user experience is requested. For example, the dynamic user experiences may use dynamic data (e.g., data that is obtained or updated at, or near, the time when a dynamic user experience is requested). Therefore, tile specifications for providing such dynamic user experiences may not include data in certain fields or information elements because the data need to be obtained or updated at, or near, the time when a dynamic user experience is requested.

The system may store the unhydrated tile specifications using a content management storage system because the unhydrated tile specifications are used to provide content (e.g., dynamic user experiences) to client devices. For example, an unhydrated tile specification may be stored as a piece of content (e.g., an article) in the content management storage system. Additionally, one or more content keys for one or more dynamic user experiences may be stored via the content management storage system. However, such content management storage systems are often managed and/or controlled externally or separate from the system that provides the tile specifications for dynamic user experiences. Therefore, to provide a dynamic user experience and/or to test a dynamic user experience, the system may need to transmit a request for an unhydrated tile specification for the dynamic user experience to the content management storage system, receive the unhydrated tile specification from the content management storage system, convert the unhydrated tile specification into a hydrated tile specification (e.g., a tile specification in a standardized format or a format which can be rendered or decoded by a client device, with dynamic data inserted), and transmit the hydrated tile specification to a device (e.g., where the device decodes the hydrated tile specification and renders the dynamic user experience for a user interface based on the hydrated tile specification). Additionally, the system may need to obtain one or more content keys (e.g., for a content file indicating data or information to be inserted into the unhydrated tile specification when converting the unhydrated tile specification to a hydrated tile specification).

This increases latency and consumes network resources and/or processing resources, among other examples, associated with the system providing the hydrated tile specification for the dynamic user experience. For example, because the content management storage system is external to the system providing the hydrated tile specification, the system may make direct calls (e.g., API calls) to the content management storage system to obtain the unhydrated tile specification and/or one or more content keys. The calls may increase latency and consume resources (e.g., network resources and/or processing resources) associated with the system providing the hydrated tile specification for the dynamic user experience. Additionally, because the system may need to continually and/or periodically manage the set of unhydrated tile specifications stored via the content management storage system. Because the content management storage system is external from the system, this may be a time consuming and/or resource intensive process requiring specialized knowledge of the content management storage system. Further, by the unhydrated tile specifications being stored in the content management storage system, a risk of the unhydrated tile specifications being unavailable or unobtainable may be increased because the system is dependent on the content management storage system being online and/or available to obtain unhydrated tile specifications (e.g., if the content management storage system is unavailable or goes offline, the system may be unable to obtain unhydrated tile specifications).

As described above, the unhydrated tile specifications may be code written in the specification language. However, the content management storage system may store the unhydrated tile specifications as individual pieces of textual content. Therefore, the content management storage system may treat the unhydrated tile specifications as plain text for easy retrieval, display, and/or interaction, typically without needing to interpret the structure of the unhydrated tile specifications. This increases the risk that the content management storage system may introduce errors and/or not adhere to syntax rules for the unhydrated tile specifications (such as during updates or new system releases for the content management storage system).

Some implementations described herein enable integrated tile specification storage. For example, a tile provider system may include a storage component and a tile provider component. The tile provider system may store, via the storage component, one or more unhydrated tile specifications for one or more dynamic user experiences. The tile provider system may store, via the storage component, one or more content keys (e.g., one or more content key-value pairs) that indicate data that is insertable into one or more blank fields of the one or more unhydrated tile specifications. In some implementations, the storage component may store the one or more unhydrated tile specifications and the one or more content key-value pairs in a cloud storage bucket included in a cloud computing environment. As another example, the storage component may store the one or more unhydrated tile specifications in application code that is executable to cause the system to provide the one or more dynamic user experiences.

The tile provider system may receive, from a device, a request that indicates a dynamic user experience from the one or more dynamic user experiences. The tile provider system may obtain, from the storage component, an unhydrated tile specification from the one or more unhydrated tile specifications based on the dynamic user experience. The unhydrated tile specification may be in a format in which the device cannot decode or render the dynamic user experience using the unhydrated tile specification (e.g., in a non-standardized or decodable format). In some examples, the tile provider system may obtain, from the storage component and via the interface, at least one content key-value pair from the one or more content key-value pairs based on the request.

The tile provider system may automatically generate a hydrated tile specification based on the unhydrated tile specification and the at least one content key-value pair, wherein the hydrated tile specification can be rendered by the device. As used herein “automatically” may refer to the tile provider system generating the hydrated tile specification autonomously, independently, preemptively, without help, in an unassisted manner, in an unprompted manner, and/or by default, among other examples (e.g., without obtaining an instruction or command to do so). For example, the tile provider system automatically generating the hydrated tile specification may include the tile provider system converting the unhydrated tile specification from an undecodable format to a decodable format (e.g., a format in which the device can decode and/or render the dynamic user experience based on the hydrated tile specification). The tile provider system may transmit, to the device, the hydrated tile specification to cause the device to render and display the dynamic user experience via a user interface.

As a result, the tile provider system may integrate the storage of the unhydrated tile specifications and content keys within the storage component (e.g., which is managed by and/or a part of the tile provider system). This enables the tile provider system to manage and/or control the storage of the unhydrated tile specifications. Additionally, this enables the tile provider system to manage and/or control the storage content keys which can be used to convert the unhydrated tile specifications to hydrated tile specifications (e.g., to convert the unhydrated tile specifications from undecodable to decodable). For example, by the tile provider system obtaining the unhydrated tile specification and/or one or more content keys from the storage component, the tile provider system may reduce latency and/or conserve resources (e.g., network resources and/or processing resources) that would have otherwise been associated with the tile provider system providing the hydrated tile specification for the dynamic user experience using a content management storage system. This enables the tile provider system to quickly generate a hydrated tile specification which can be used by the device to render the dynamic user experience natively for the user interface displayed by the device.

Additionally, integrating the storage of the unhydrated tile specifications and/or the content keys into the storage component enables the tile provider system to store and/or manage the unhydrated tile specifications and/or the content keys as code (e.g., rather than as textual content). This increases the likelihood that syntax and/or a structure of the unhydrated tile specifications and/or the content keys is properly maintained in storage. This improves the reliability and/or resiliency of the unhydrated tile specifications and/or the content keys in storage. Further, by the tile provider system storing the unhydrated tile specifications and/or the content keys in the storage component, the tile provider system (and/or the tile provider component) can directly access the unhydrated tile specifications and/or the content keys without having to communicate with an external or separate system. This enables faster data retrieval and improved performance and/or simplified architecture for the tile provider system, thereby reducing the potential for bottlenecks or failures introduced by content management storage system. Additionally, this enables the tile provider system to scale or create new versions of tile specifications for dynamic user experiences with reduced latency and less resource overhead.

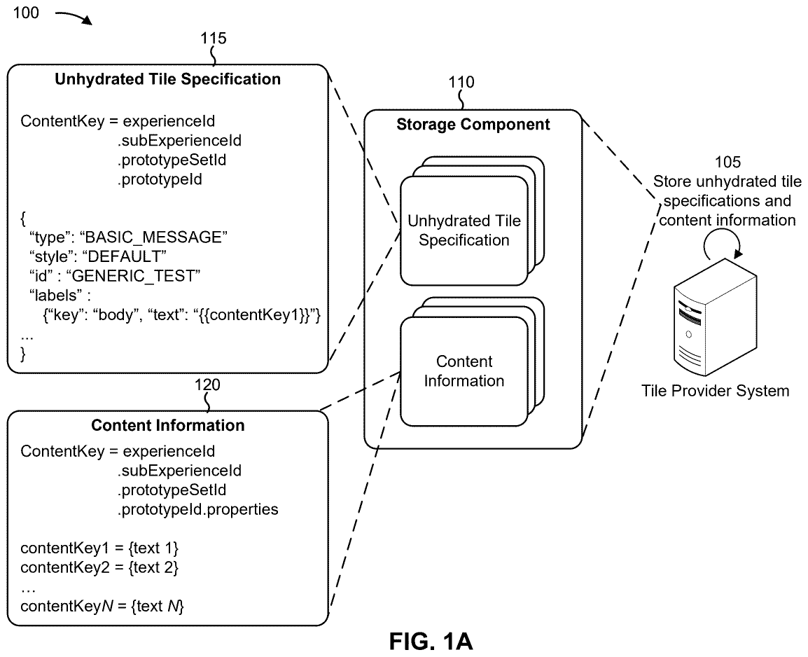

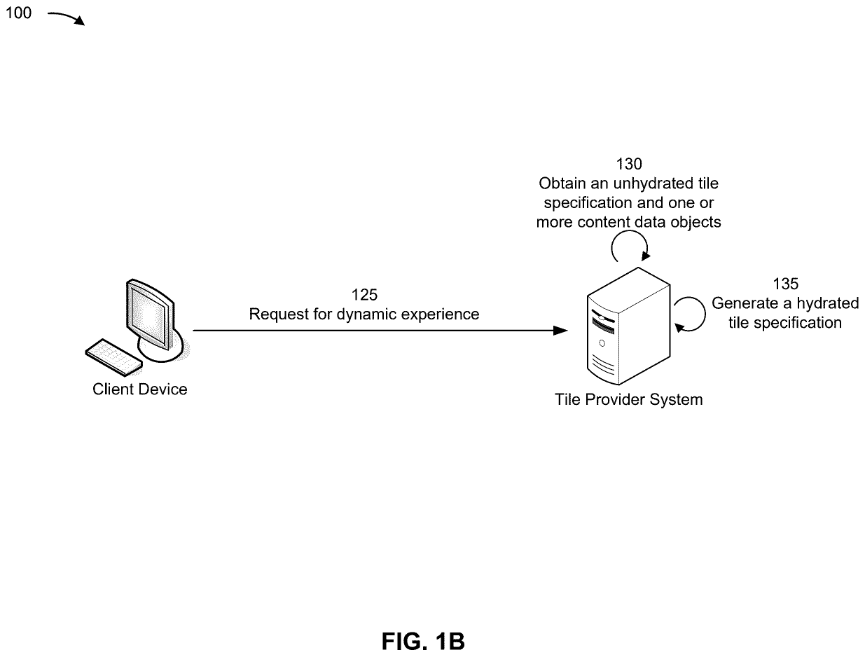

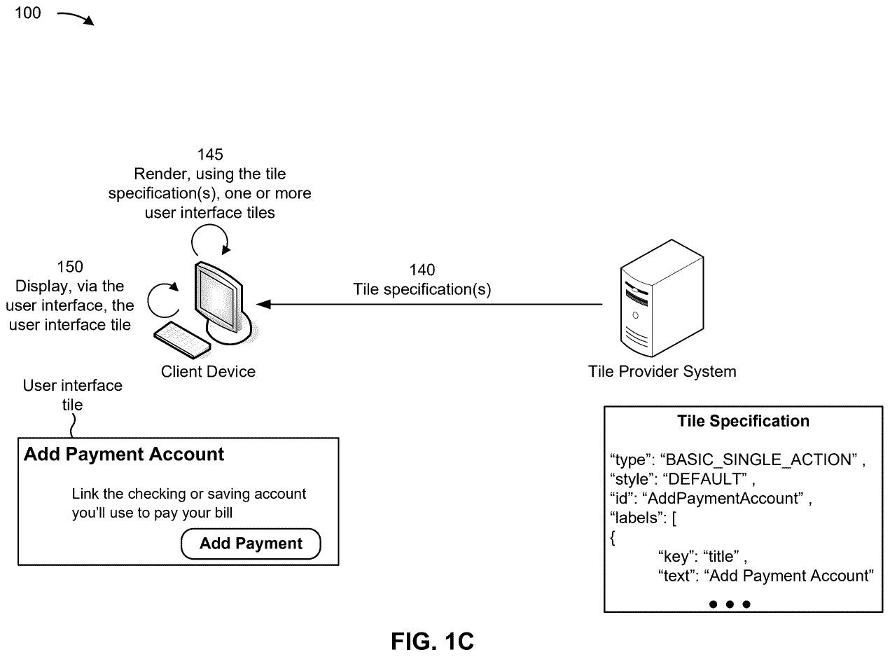

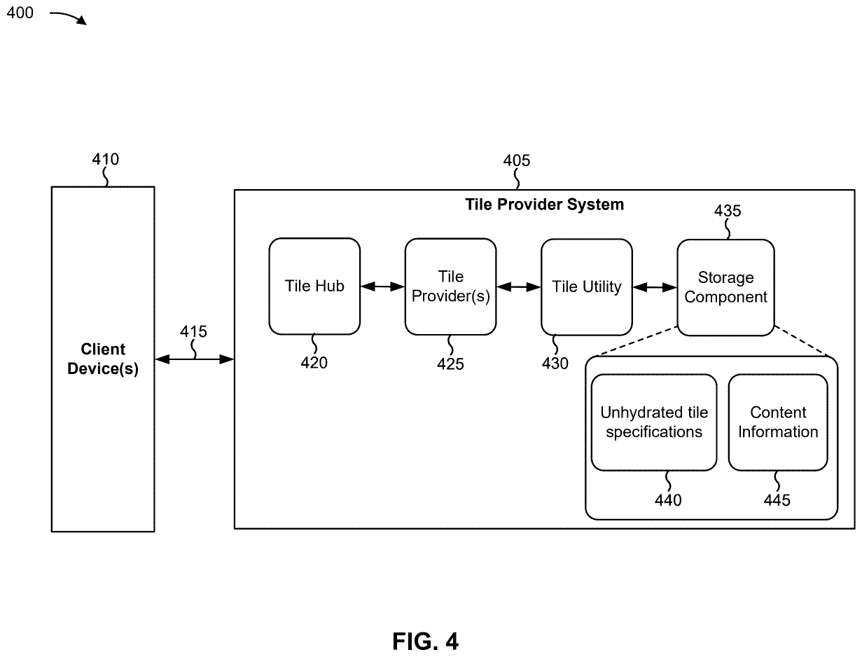

FIGS. 1A-1C are diagrams of an example 100 associated with integrated tile specification storage. As shown in FIGS. 1A-1C, example 100 includes a tile provider system and a client device. These devices are described in more detail in connection with FIGS. 4-6.

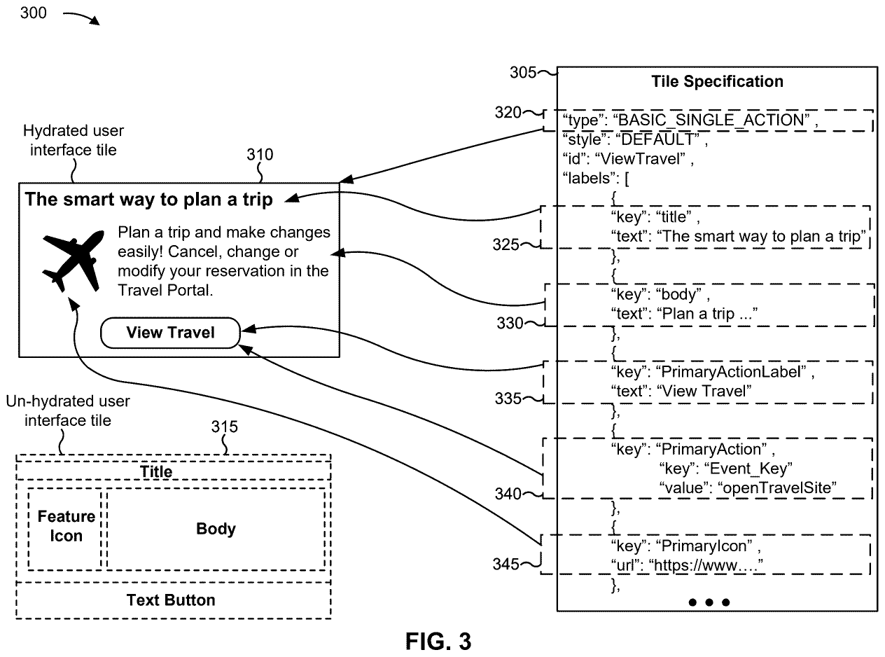

As shown in FIG. 1A, and by reference number 105, the tile provider system may store one or more unhydrated tile specifications and content information via a storage component 110. For example, the tile provider system may store, via the storage component 110, one or more unhydrated tile specifications for one or more dynamic user experiences. An example unhydrated tile specification 115 is shown in FIG. 1A. Tile specifications are depicted and described in more detail in connection with FIG. 3. The storage component 110 may include one or more storage locations. For example, the storage component 110 may include a storage location for the one or more unhydrated tile specifications. Additionally, the storage component 110 may include a storage location for content information 120.

The unhydrated tile specification 115 may be an information set that defines how to render a user interface tile and/or what information is to be included in the user interface tile. The unhydrated tile specification 115 may be a data object that includes one or more key-value pairs and/or an ordered list (or array) of values that indicate the information set. In some implementations, the unhydrated tile specification 115 may use code, such as JSON code, to indicate the information set. For example, the unhydrated tile specification 115 may be a JSON object, a JSON payload, and/or a JSON document.

The unhydrated tile specification 115 may indicate a content key. The content key may include one or more identifiers (e.g., one or more dynamic user experience identifiers or prototype set identifiers) to be used to identify and/or obtain the unhydrated tile specification 115. The unhydrated tile specification 115 may indicate a type (shown as “BASIC_MESSAGE”) of the user interface tile to be used to provide a dynamic user experience. The type may indicate that the user interface tile template is to be used to render the user interface tile. The unhydrated tile specification 115 may include a style (e.g., indicating a style of the user interface tile template) and an identifier (e.g., an identifier of the unhydrated tile specification 115).

The unhydrated tile specification 115 may include one or more labels (e.g., key-value pairs) for indicating information to be included in the user interface tile and/or actions to be provided by the user interface tile. The one or more labels may indicate user interface information for the user interface tile. The one or more labels may indicate information and/or elements to be inserted into the one or more fields of the user interface tile template. The unhydrated tile specification 115 may include one or more blank fields or elements. For example, one or more of the labels may be blank and/or may include placeholder information that is to be replaced with dynamic data when a dynamic user experience is provided by the tile provider system. For example, as shown in FIG. 1A, one or more content keys may be identified in the unhydrated tile specification 115 (e.g., shown in FIG. 1A as “contentKey1”). The content key may include information that is to be inserted into one or more fields or elements of the unhydrated tile specification 115 when the unhydrated tile specification 115 is converted to a hydrated tile specification.

The tile provider system may store, via the storage component 110, the content information. The content information may include one or more content keys. For example, the content information may include one or more content key-value pairs that indicate data that is insertable into one or more blank fields of the one or more unhydrated tile specifications, such as the unhydrated tile specification 115. For example, as shown in FIG. 1A, content information 120 may be stored via the storage component 110. The content information 120 may include a content key. The content key may include one or more identifiers (e.g., one or more dynamic user experience identifiers or prototype set identifiers) to be used to identify and/or obtain the content information 120 (e.g., similar to the content key of the unhydrated tile specification 115). The content information 120 may include one or more content key-value pairs that indicate data that is insertable into one or more blank fields of the one or more unhydrated tile specifications, shown in FIG. 1A as content keys 1 through N. For example, the ContentKey1 which is to be inserted into the unhydrated tile specification 115 (e.g., when converting the unhydrated tile specification 115 into a hydrated tile specification) may be included in the content information 120.

In some implementations, the tile provider system may store the one or more unhydrated tile specifications and the content information in a cloud storage bucket included in a cloud computing environment. For example, the storage component 110 may include the cloud storage bucket. The tile provider system may be configured to operate in the cloud computing environment. For example, a tile provider component of the tile provider system may be a component in the cloud computing environment. This enables the tile provider system to directly access and/or manage the one or more unhydrated tile specifications and the content information within the cloud computing environment. This reduces latency and reduces architecture complexity associated with storing and/or accessing the one or more unhydrated tile specifications and the content information.

In some implementations, the tile provider system may store the one or more unhydrated tile specifications and the content information in application code that is executable to cause the tile provider system to provide the one or more dynamic user experiences, such as to the client device. For example, one or more components of the tile provider system (such as a tile provider 425 described in connection with FIG. 4) may execute the application code to perform functions associated with providing dynamic user experiences. The storage component 110 may be a code storage component. The one or more unhydrated tile specifications may be stored as one or more files (e.g., JSON files) within the application code. In such examples, the content key used to find the unhydrated tile specification 115 may be a file name of the unhydrated tile specification 115. Similarly, the application code may include one or more content files (or content bundles) that indicate the content information 120. In such examples, the content key of the content information 120 may be a file name of the content information 120.

By the tile provider system storing the one or more unhydrated tile specifications and/or the content information in the application code, the tile provider system may access the one or more unhydrated tile specifications and/or the content information directly from the application code. This eliminates the need for the tile provider system to communicate with another component or system to access the one or more unhydrated tile specifications and/or the content information (e.g., the tile provider system does not need to make any API calls to access the one or more unhydrated tile specifications and/or the content information). This reduces latency and conserves network resources associated with accessing or retrieving the one or more unhydrated tile specifications and/or the content information. Additionally, this ensures that the tile provider system treats and/or manages the one or more unhydrated tile specifications and/or the content information as code, rather than as textual content.

In some implementations, the one or more unhydrated tile specifications and/or the one or more content key-value pairs of the content information may be bundled resources within the application code. For example, one or more unhydrated tile specifications and one or more content key-value pairs may be bundled into one or more files to improve performance associated with accessing or retrieving the one or more unhydrated tile specifications and/or the content information (e.g., because the tile provider system can reduce the number of requests or operations associated with accessing or retrieving the one or more unhydrated tile specifications and/or the content information due to the bundling). As another example, one or more content key-value pairs for a given dynamic user experience may be bundled into one or more files. For example, the bundled resources may be associated with a given dynamic user experience. This enables the tile provider system to quickly identify and/or obtain one or more unhydrated tile specifications and/or the one or more content key-value pairs using an identifier of the given dynamic user experience. This reduces latency and/or conserves resources (e.g., processing resources) that would have otherwise been associated with the tile provider system separately obtaining each unhydrated tile specification and/or each content key-value pair for the given dynamic user experience.

In some implementations, the tile provider system may store the one or more unhydrated tile specifications and the content information in one or more records of a not only structured query language (SQL) (NoSQL) database (e.g., a non-relational database that stores data in a non-tabular format, rather an a rule-based format). For example, the storage component 110 may include the NoSQL database. In such examples, the unhydrated tile specification 115 may be stored as an attribute of a table in the NoSQL database. In such examples, the content key of the unhydrated tile specification 115 may be a partition key. Similarly, the content information 120 may be stored as an attribute of the table in the NoSQL database. In such examples, the content key of the content information 120 may be a partition key. For example, the NoSQL database may be a database included in a tile registry used by the tile provider system to obtain protypes of tile specifications.

In some implementations, the tile provider system may provide remote access to the storage component 110 to enable unhydrated tile specifications to be directly stored or modified. The remote access may include an endpoint (e.g., an API endpoint) or other communication interface for the storage component 110, which another device can directly call or access. For example, because the storage component 110 is included in a system or environment in which the tile provider system operates, the tile provider system may provide remote access over a network for another device (such as the client device or a user device) to directly access and/or modify the unhydrated tile specifications. This enables the other device to directly access, create, and/or modify unhydrated tile specifications (e.g., via a user interface) without having to manually write the unhydrated tile specifications and/or store the unhydrated tile specifications in a separate or external system.

For example, a dynamic user experience may be associated with multiple variants of the dynamic user experience. For example, the multiple variants may be associated with experimentation for a user experience to determine which variant is associated with a highest performance level (e.g., the highest engagement, the best usability, the best accessibility, the best visual design, the best responsiveness, and/or the best ease of navigation). As another example, as new features and/or user interface actions are introduced, a variant including the new features and/or user interface actions may be created. This ensures that the new features and/or user interface actions are not deployed or distributed to the entire population of users. For example, the new features and/or user interface actions may have a risk of introducing unexpected problems or errors. The tile provider system may throttle the rollout of the new features and/or user interface actions using a variant to reduce the likelihood of the problems or errors being experienced by the entire population of users. The remote access to the storage component 110 may enable the other device to create and/or manage the multiple variants of a given dynamic user experience with reduced latency and/or complexity.

As another example, the remote access may reduce latency and/or complexity for onboarding new dynamic user experiences. For example, the other device may access or obtain an unhydrated tile specification from the storage component to use as a template or starting point for the creation of an unhydrated tile specification for a new dynamic user experience. Additionally, the remote access may enable the other device to cause one or more unhydrated tile specifications to be stored via the storage component 110 without requiring another team or device to create and/or store the one or more unhydrated tile specifications. This reduces the latency and/or complexity associated with onboarding or creating new dynamic user experiences.

As shown in FIG. 1B, and by reference number 125, the client device may transmit, and the tile provider system may receive, a request (e.g., a client request) for a dynamic user experience. For example, the client device may determine the dynamic user experience based on user interaction with the user interface. The client device may determine the dynamic user experience based on the user interface, the page, and/or other information to be displayed via the user interface. The request for the dynamic user experience may include an identifier of the dynamic user experience. As another example, the client device may be used to test or display a mock example of the dynamic user experience. In such examples, the client device may obtain, via a user interaction with the user interface, an indication of the dynamic user experience that is to be tested or displayed.

As shown by reference number 130, the tile provider system may obtain an unhydrated tile specification for the dynamic user experience. In some examples, the tile provider system may obtain one or more content data objects (e.g., one or more content key-value pairs) for the dynamic user experience. For example, the tile provider system may obtain the unhydrated tile specification via the storage component 110. The tile provider system may identify an identifier of the dynamic user experience based on the dynamic user experience indicated by the request. The tile provider system may search, via the storage component 110, for an unhydrated tile specification that includes the identifier of the dynamic user experience (such as in the content key, the file name, or a partition key).

In some implementations, the tile provider system may execute the application code to obtain the unhydrated tile specification and/or the one or more content data objects (e.g., one or more content key-value pairs from the content information 120) that are stored in the application code. For example, in cases where the unhydrated tile specification and/or the one or more content data objects are stored in the application code, executing the application code may cause the tile provider system to obtain the unhydrated tile specification and/or the one or more content data objects. This enables the tile provider system to obtain the unhydrated tile specification and/or the one or more content data objects without making any external communications or calls, thereby reducing latency and/or conserving network resources, among other examples.

In some implementations, the tile provider system may search, via the storage component 110, for content data objects (e.g., files, content key value-pairs, or other data objects) in the content information 120 that includes the identifier of the dynamic user experience (such as in the content key, the file name, or a partition key). In some implementations, the unhydrated tile specification may include an identifier of a data object (e.g., of a content key-value pair). For example, a field in a label of the unhydrated tile specification may include an identifier of a data object stored in the content information 120.

In such examples, the tile provider system may filter the content information 120 using the identifier to identify the content data object. For example, the tile provider system may filter one or more content key-value pairs stored in the storage component 110 using the identifier of the included in the identified unhydrated tile specification. This reduces the latency and/or complexity associated with identifying and/or accessing the data that is to be inserted into the unhydrated tile specification that would have otherwise been associated with searching for the content data object (e.g., one or more content key-value pairs) without such filtering.

For example, by integrating the storage of the unhydrated tile specifications and the content information in the storage component 110, the tile provider system may quickly and easily identify an unhydrated tile specification and information to be used to convert the unhydrated tile specification to a hydrated tile specification from the storage component 110. This reduces the complexity associated with generating a hydrated tile specification for a prototype or testing scenario in which actual dynamic data is not available to be inserted into the unhydrated tile specification. For example, the one or more data objects may include mock or example dynamic data. This enables the tile provider system to create a hydrated tile specification for the prototype or testing scenario which enables the client device to render and display a realistic visualization of the dynamic user experience (e.g., using the mock or example dynamic data indicated by the one or more data objects). This improves testing performance because the client device displays an accurate depiction or visualization of what the dynamic user experience will be in practice, thereby enabling a user (or tester) to view the dynamic user experience without accessing real dynamic data. The improved testing may improve the reliability and/or resilience of the unhydrated tile specifications across different scenarios, thereby improving the performance of the dynamic user experiences provided by the tile provider system.

As shown by reference number 135, the tile provider system may generate a hydrated tile specification for the dynamic user experience. For example, the tile provider system may automatically generate the hydrated tile specification, such as without communicating with an external or separate storage system (such as a content management storage system). For example, the tile provider system may convert the unhydrated tile specification into the hydrated tile specification, such as based on the one or more content data objects and/or other dynamic data.

For example, the tile provider system may insert the one or more content data objects into the at least one blank field to generate the hydrated tile specification. In some implementations, the tile provider system may insert one or more content key-value pair into one or more blank fields of the unhydrated tile specification to generate the hydrated tile specification. As another example, the tile provider system may replace a placeholder element with a content data object (e.g., with one or more content key-value pairs) to generate the hydrated tile specification.

As an example, the one or more blank fields may be configured for dynamic data (e.g., may be configured to have dynamic data inserted into the one or more blank fields). In some examples, the request (e.g., the client request) may be for a prototype of the dynamic user experience. In such examples, the tile provider system may insert the one or more content data objects (e.g., the one or more content key-value pairs) into at least one blank field of the unhydrated tile specification to generate the hydrated tile specification. The one or more content data objects (e.g., the one or more content key-value pairs) may include prototype dynamic data for the dynamic user experience. This enables the tile provider system to generate a hydrated tile specification which can be used to render a realistic and/or accurate visualization of the dynamic user experience for the prototype of the dynamic user experience.

As shown in FIG. 1C, and by reference number 140, the tile provider system may transmit, and the client device may receive, the hydrated tile specification. The tile specification may indicate user interface information for a user interface tile associated with the dynamic user experience (e.g., requested by the client device as described in connection with reference number 125). As described in more detail elsewhere herein, the specification may be a data object that indicates user interface information in a channel agnostic manner. The structure and/or content of the tile specification is depicted and described in more detail in connection with FIG. 3.

As shown by reference number 145, the client device may render, using the hydrated tile specification, a user interface tile. For example, the client device may render one or more user interface elements associated with the user interface tile based on the hydrated tile specification. For example, the client device may interpret and/or decode the hydrated tile specification to obtain (e.g., extract) the user interface information. The client device may use a rendering engine (e.g., of the client device and/or an application executing on the client device) to process the user interface information and translate the user interface information into visual components (e.g., native components) of a user interface framework that the client device is configured to use. The client device may render the user interface tile (e.g., using the user interface information obtained from the hydrated tile specification) in accordance with the rendering engine, operating system, and/or user interface framework that is used by the client device and/or the application. For example, the client device may obtain information for user interface templates and/or user interface actions (e.g., indicated by the hydrated tile specification) from local libraries (e.g., stored by the client device and/or accessible by the client device), as described in more detail elsewhere herein (such as in connection with FIG. 4). This reduces the complexity and increases the flexibility for modifying and/or updating user experiences provided by the user interface because the client device (and/or the application) can use the rendering engine and/or visual components (e.g., native components) of the user interface framework of the client device (and/or the application). As shown by reference number 150, the client device may display, via a client user interface, the user interface tile. For example, the client device may provide the one or more user interface elements of the user interface tile for display via the client user interface.

As indicated above, FIGS. 1A-1C are provided as an example. Other examples may differ from what is described with regard to FIGS. 1A-1C.

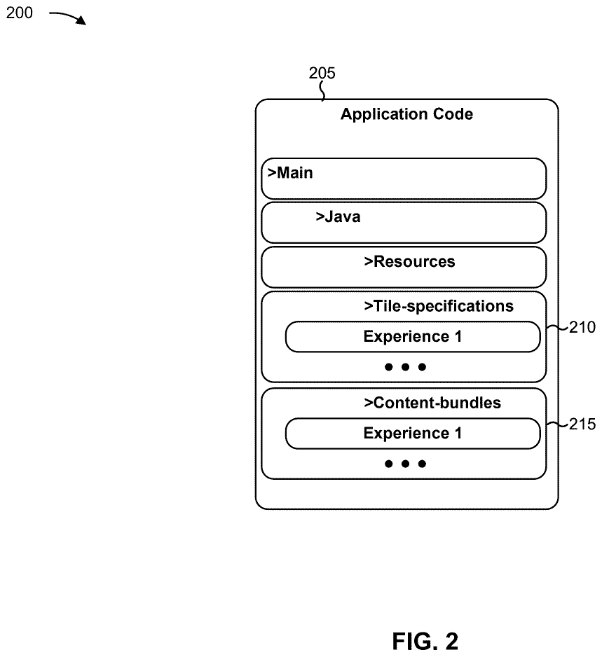

FIG. 2 is a diagram of an example 200 associated with integrated tile specification storage. As shown in FIG. 2, application code 205 may be used by the tile provider system to provide one or more dynamic user experiences. One or more unhydrated tile specifications 210 (such as the unhydrated tile specification 115) and/or content information 215 (such as the content information 120) may be stored in the application code 205.

For example, the application code 205 may include one or more resources. “Resource” may refer to external assets or components that the tile provider system relies on to function properly using the application code 205. For example, a resource may be a static file, a configuration file, an external service (e.g., an API or database), and/or a computing resource, among other examples. When the tile provider system executes the application code 205 (or a portion of the application code 205), the tile provider system may obtain information or one or more files from the resources.

As shown in FIG. 2, a resource of the application code 205 may include the one or more unhydrated tile specifications 210. For example, the one or more unhydrated tile specifications 210 may be stored via one or more files in the resources of the application code 205. For example, a file may be associated with (or mapped to) a given dynamic user experience. When the given dynamic user experience is requested, the tile provider system can obtain the file from the resources of the application code 205.

As another example, a resource of the application code 205 may include the content information 215. For example, one or more content data objects (and/or one or more content key-value pairs) may be stored as resources (e.g., bundled resources) in the application code 205. For example, a file in the resources may include one or more bundled content data objects for a given dynamic user experience. When the given dynamic user experience is requested, the tile provider system can obtain the file from the resources of the application code 205.

This reduces the complexity associated with the tile provider system obtaining and/or accessing the unhydrated tile specification and/or content data objects for a requested dynamic user experience because the tile provider system does not need to communicate or call an external data source or system. Additionally, by the tile provider system storing the one or more unhydrated tile specifications 210 and/or the content information 215 in the application code 205 (e.g., as resources), the tile provider system may ensure that the one or more unhydrated tile specifications 210 and/or the content information 215 are treated or managed as code, thereby improving the reliability and/or resiliency of the one or more unhydrated tile specifications 210 and/or the content information 215 in storage.

As indicated above, FIG. 2 is provided as an example. Other examples may differ from what is described with regard to FIG. 2.

FIG. 3 is a diagram of an example 300 associated with a tile specification 305 for dynamic user interface tiles. As described elsewhere herein, the tile specification 305 may include information (e.g., code and/or instructions) that enables a client device (e.g., the client device described in connection with FIGS. 1A-1D and 2 and/or elsewhere herein) to render a user interface tile 310 (e.g., shown in FIG. 3 as a hydrated user interface tile). As used herein, a “hydrated” user interface tile refers to a user interface tile with inserted data or information (e.g., as indicated by the tile specification 305). The tile specification 305 may be an example of a hydrated tile specification.

For example, a user interface tile template 315 may define a template for a type 320 of user interface tile. The user interface tile template 315 may be an unhydrated user interface tile (e.g., a user interface tile without data or information inserted). For example, the user interface tile template 315 may define a generic template for the type 320 of user interface tile. As shown in FIG. 3, the user interface tile template 315 may indicate a location, position, orientation, and/or size for one or more fields. As shown in FIG. 3, the one or more fields may include a title, a feature icon, a label, and/or a text button, among other examples. The one or more fields may correspond to user interface elements of the user interface tile 310.

The tile specification 305 may be an information set that defines how to render the user interface tile 310 and/or what information is to be included in the user interface tile 310. The tile specification 305 may be a data object that includes one or more key-value pairs and/or an ordered list (or array) of values that indicate the information set. In some implementations, the tile specification 305 may use code, such as JSON code, to indicate the information set. For example, the tile specification 305 may be a JSON object, a JSON payload, and/or a JSON document.

The tile specification 305 may indicate the type 320 of the user interface tile 310. The type 320 may indicate that the user interface tile template 315 is to be used to render the user interface tile 310. For example, the type 320 may enable the client device to identify the user interface tile template 315 that is to be used to render the user interface tile 310. The user interface tile template 315 may define or indicate one or more native components (e.g., the one or more fields) to be used by the client device to render the user interface tile 310. The type 320 of the user interface tile 310 may be a basic single action tile (e.g., a user interface tile configured or designed to enable a user to perform a basic single action, such as navigate to a travel website as shown in FIG. 3). Other types of user interface tiles may be defined or configured (e.g., for performing other actions or displaying other types of content) in a similar manner, such as by using other user interface tile templates.

The tile specification 305 may include one or more labels (e.g., key-value pairs) for indicating information to be included in the user interface tile 310 and/or actions to be provided by the user interface tile 310. The one or more labels may indicate user interface information for the user interface tile 310. The one or more labels may indicate information and/or elements to be inserted into the one or more fields of the user interface tile template 315. For example, the one or more labels may define text content to be displayed via the user interface tile 310. An image element in the tile specification 305 may define image content to be displayed.

As shown in FIG. 3, the one or more labels may include a title 325. The title 325 may indicate information to be inserted into a title field of the user interface tile template 315. For example, a key value may indicate that the information is associated with the title 325 and text value may indicate the text to be inserted into the title field (e.g., “The smart way to plan a trip” as shown in FIG. 3). The one or more labels may include a body 330. The body 330 may indicate information to be inserted into the body of the user interface tile template 315, such as the label field shown in FIG. 3. For example, a key value may indicate that the information is associated with the body 330 and text value may indicate the text to be inserted into the label field shown in FIG. 3.

The one or more labels may include an action label 335. The action label 335 may indicate information (e.g., text) to be used as a label for an interactive user interface element that is configured to enable the user to perform an action. For example, as described above, the type 320 may be associated with a single action. The user interface tile template 315 may include a field associated with an interactive user interface element that, when interacted with by a user, causes the client device to perform an action. For example, the field associated with an interactive user interface element is shown in FIG. 3 as the text button field. The action label 335 may indicate a label for the interactive user interface element to be included in the user interface tile 310. For example, a key value may indicate that the information is associated with the action label 335 and text value may indicate the text to be inserted as the label (e.g., “View Travel” as shown in FIG. 3). An action element may define the behavior that should be performed when a user interacts (e.g., selects) the interactive user interface element.

The tile specification 305 may indicate one or more actions 340 to be enabled by the user interface tile 310. For example, the one or more actions 340 may be one or more actions to be performed by the client device based on a user interacting with an interactive user interface element of the user interface tile 310. For example, the one or more actions 340 may indicate what the client device is to do based on (e.g., when or after) detecting that a user has interacted with an interactive user interface element of the user interface tile 310. In some implementations, such as when the type 320 is associated with multiple actions, the one or more actions 340 may indicate which interactive user interface elements respective actions of the multiple actions are to be associated with. As an example, the one or more actions 340 indicated by the tile specification 305 may include navigating to a travel website or page (e.g., the travel website or page may be indicated by the value “openTravelSite” as shown in FIG. 3). The client device may configure the user interface tile 310 such that the client device navigates to the indicated travel website or page based on a user interacting with (e.g., clicking, selecting, or touching) the interactive user element (e.g., shown with the action label 335 of “View Travel” in FIG. 3).

The tile specification 305 may indicate image content to be displayed via the user interface tile 310. For example, the tile specification 305 may indicate an icon 345 to be displayed via the user interface tile 310. The tile specification 305 may indicate a source from which the image content can be obtained or retrieved. For example, as shown in FIG. 3, the tile specification 305 may indicate a uniform resource locator (URL) from which the icon 345 shown in the user interface tile 310 can be obtained or retrieved.

The tile specification 305 shown in FIG. 3 is provided as an example. In other examples, a tile specification may indicate different labels, a different quantity of labels, a different type 320, different action(s) 340, and/or a different quantity of actions 340, among other examples. Additionally, the tile specification 305 may define image content, questions, and/or options, among other examples, to be displayed via the user interface tile 310. The tile specification 305 may enable the user interface tile template 315 to be reused for different user experiences. For example, by the tile provider system changing information indicated by the tile specification 305 for the type 320, the user interface tile template 315 can be used by the client device to render user interface tiles for different user experiences. Additionally, the tile provider system can dynamically update a user experience by changing information indicated by the tile specification 305 for the type 320, thereby enabling the client device to render the user interface tile 310 based on the changed information and the user interface tile template 315. This reduces the complexity associated with updating or changing user experiences by the tile provider system defining or configuring the user experiences in a channel-agnostic manner using the tile specification 305.

As indicated above, FIG. 3 is provided as an example. Other examples may differ from what is described with regard to FIG. 3.

FIG. 4 is a diagram of an example 400 associated with a tile provider system 405 for dynamic user interface tiles. The tile provider system 405 may communicate the one or more client devices 410 via a communication interface 415. The tile provider system 405 may be, or may be similar to, the tile provider system described in connection with FIGS. 1A-1C and 3. similarly, the one or more client devices 410 may be, or may be similar to, the client device described in connection with FIGS. 1A-1D, and 3.

The one or more communication interfaces 415 may include a wireless connection and/or a wired connection. In some implementations, the one or more communication interfaces 415 may include one or more APIs, a transmission control protocol (TCP) interface, a message queue interface, a remote procedure call interface, a simple mail transfer protocol (SMTP) interface, a simple object access protocol (SOAP) interface, and/or an Internet protocol (IP) interface, among other examples. For example, the tile provider system 405 and the one or more client devices 410 may be configured to communicate one or more tile specifications, and/or capability information, among other examples, via the one or more communication interfaces 415.

The client device(s) 410 may include a rendering component (e.g., an engine) configured to interpret and/or decode tile specifications and render user interface tiles. The engine may include a plugin or module configured for interpreting and/or decoding tile specifications, such as the tile specification 305. The client device(s) 410 may include, or be configured to access, one or more libraries. For example, the one or more libraries may include a tile type library, and/or an action library, among other examples. A tile type library may include user interface tile templates (such as the user interface tile template 315) for respective types (such as the type 320) of user interface tiles. An action library may include information for different types of actions to be performed by the client device(s) 410, such as the one or more actions 340. The one or more libraries may include information that is specific to a channel, a framework (e.g., a coding framework), and/or ecosystem, among other examples in which a given client device 410 is configured to operate. This enables the client device 410 to obtain the information (e.g., that is specific to a channel, a framework (e.g., a coding framework), and/or ecosystem) as part of interpreting and/or decoding tile specifications, thereby enabling the client device to render the user interface tiles (e.g., as defined by the tile specification(s)) in accordance with the channel, a framework (e.g., a coding framework), and/or ecosystem examples in which the given client device 410 is configured to operate.

As shown in FIG. 4, the tile provider system 405 may include one or more components, such as a tile hub component 420 (e.g., which may be, or include, a routing component), one or more tile provider components 425, one or more tile utility components 430 (e.g., a tile resolver and/or a tile hydrator), and/or storage component 435, among other examples. The storage component 435 may be similar to the storage component 110. The tile hub component 420 may be configured to route requests for user experiences to a given tile provider component 425. For example, the tile hub component 420 may be a routing component that is configured to route requests for user experiences based on a type of user experience, and/or a client device 410 that transmitted the request(s), among other examples. For example, one or more tile provider components 425 may include a generic tile provider component and/or one or more service tile provider components. The one or more service tile provider components may be configured to generate tile specifications for respective services or respective user experiences (e.g., a service tile provider may be specific to a given user experience). The generic tile provider component may be configured to generate tile specifications for all other user experiences (e.g., that are not associated with service tile provider components).

For example, a tile provider component 425 may be configured to obtain data from one or more data sources to be included in a tile specification. The tile provider component 425 may be configured to transmit, to one or more data sources, a request for data associated with a client device 410 (e.g., associated with an account or user that is associated with the client device 410) that transmitted a request for a user experience. The tile provider component 425 may be configured to receive, from the one or more data sources, the data (sometimes referred to herein as “dynamic” data). The tile provider component 425 may be configured to communicate with the one or more tile utility components 430 to generate the tile specification(s).

For example, the one or more tile utility components 430 may include a resolver component and a hydrator component. The resolver component may be configured to identify one or more tile specifications and/or one or more user interface tile templates 315 for an indicated user experience. For example, the tile provider component 425 may transmit, and the resolver component may receive, an indication of the user experience requested by a client device 410. The resolver component may identify (e.g., from the storage component 435) one or more tile specifications and/or one or more user interface tile templates 315 for the user experience. The storage component 435 may store tile specifications, configurations, capability information, among other examples, for various user experiences. In some examples, the storage component 435 may include an experience registration database in which one or more tile specifications for a given dynamic user experience are stored.

As shown in FIG. 4, the storage component 435 may store one or more unhydrated tile specifications 440 and/or content information 445. The one or more unhydrated tile specifications 440 may be similar to the unhydrated tile specification 115 and/or the one or more unhydrated tile specifications 210. The content information 445 may be similar to the content information 120 and/or the content information 215. In some implementations, the storage component 435 may include a cloud storage bucket included in a cloud computing environment. For example, the tile provider system 405 may operate in the cloud computing environment. As another example, the storage component 435 may include a NoSQL database or an SQL database. As another example, the storage component 435 may store application code, such as the application code 205. For example, the application code 205 may be for the one or more tile utility components 430. For example, the application code 205, when executed, causes the one or more tile utility components 430 to perform one or more actions described herein, such as obtaining an unhydrated tile specification and/or obtaining one or more content data objects.

The hydrator component may be configured to insert information into one or more tile specifications. For example, the one or more tile specifications and/or one or more user interface tile templates 315 obtained by the resolver component may include one or more placeholder fields to be replaced with data (e.g., the dynamic data for the client device 410) to generate a tile specification that can be used by the client device 410 for rendering one or more user interface tiles. For example, the tile provider component 425 may transmit, and the hydrator component may receive, an indication of the one or more tile specifications and the data that was obtained by the tile provider component 425 (e.g., the dynamic data for the client device 410). The hydrator component may insert the data into the one or more tile specifications to generate one or more tile specifications that are ready for rendering by the client device 410. The hydrator component may transmit, and the tile provider component 425 may receive, the one or more tile specifications (e.g., hydrated tile specification(s)). The tile provider component 425 may cause the one or more tile specifications to be transmitted to the client device 410 (e.g., via the tile hub component 420). For example, the tile provider system 405 may transmit, and the client device 410 may receive, the one or more tile specifications (e.g., hydrated tile specification(s)) via the communication interface 415.

The client device 410 may render one or more user interface tiles based on the one or more tile specifications and the libraries described above. For example, the engine of the client device may be configured to render the one or more user interface tiles based on the one or more tile specifications and the libraries. The client device 410 may display the one or more user interface tiles via a user interface (e.g., a GUI).

As indicated above, FIG. 4 is provided as an example. Other examples may differ from what is described with regard to FIG. 4.

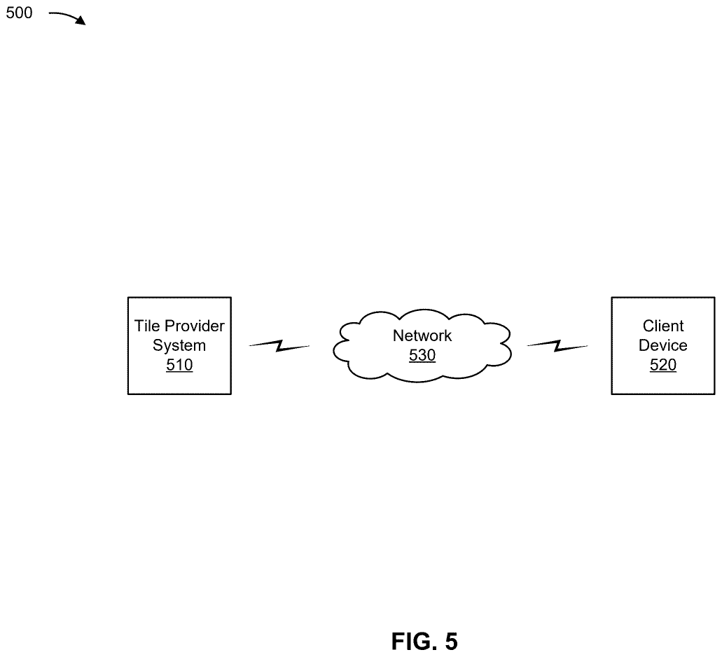

FIG. 5 is a diagram of an example environment 500 in which systems and/or methods described herein may be implemented. As shown in FIG. 5, environment 500 may include a tile provider system 510 (e.g., the tile provider system 405), a client device 520 (e.g., the client device 410), and a network 530. Devices of environment 500 may interconnect via wired connections, wireless connections, or a combination of wired and wireless connections.

The tile provider system 510 may include one or more devices capable of receiving, generating, storing, processing, providing, and/or routing information associated with tile specification generation for dynamic user interface tiles, as described elsewhere herein. The tile provider system 510 may include a communication device and/or a computing device. For example, the tile provider system 510 may include a server, such as an application server, a client server, a web server, a database server, a host server, a proxy server, a virtual server (e.g., executing on computing hardware), a server in a cloud computing system, and/or a serverless component in a cloud computing system (e.g., one or more serverless functions). In some implementations, the tile provider system 510 may include computing hardware used in a cloud computing environment.

The client device 520 may include one or more devices capable of receiving, generating, storing, processing, and/or providing information associated with tile specification generation for dynamic user interface tiles, as described elsewhere herein. The client device 520 may include a communication device and/or a computing device. For example, the client device 520 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 530 may include one or more wired and/or wireless networks. For example, the network 530 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 530 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

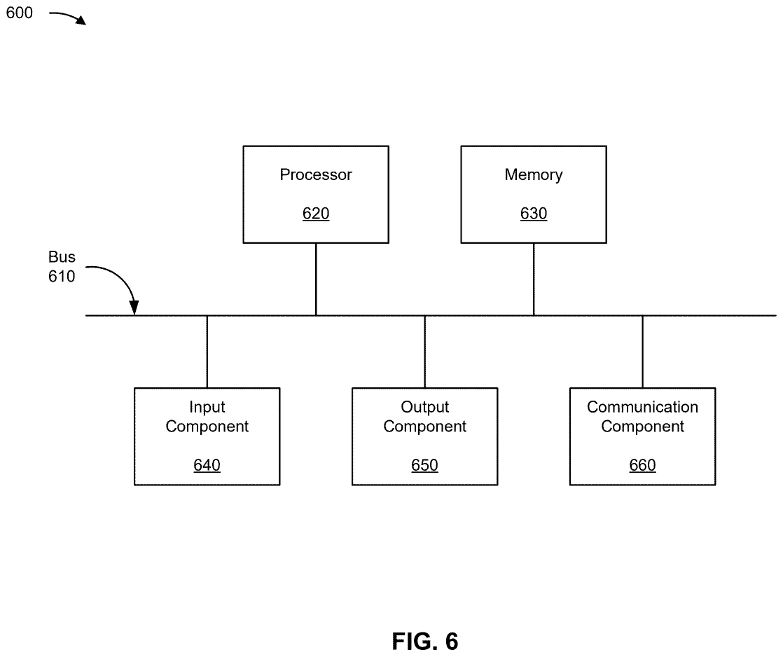

FIG. 6 is a diagram of example components of a device 600 associated with tile specification generation for dynamic user interface tiles. The device 600 may correspond to a tile provider system (e.g., the tile provider system 405 and/or the tile provider system 510), a client device (e.g., the client device 410 and/or the client device 520), the tile hub component 420, the tile provider component 425, a tile utility component 430, and/or a storage component 435. In some implementations, the tile provider system (e.g., the tile provider system 405 and/or the tile provider system 510), the client device (e.g., the client device 410 and/or the client device 520), the tile hub component 420, the tile provider component 425, the tile utility component 430, and/or the tile registry component 435 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

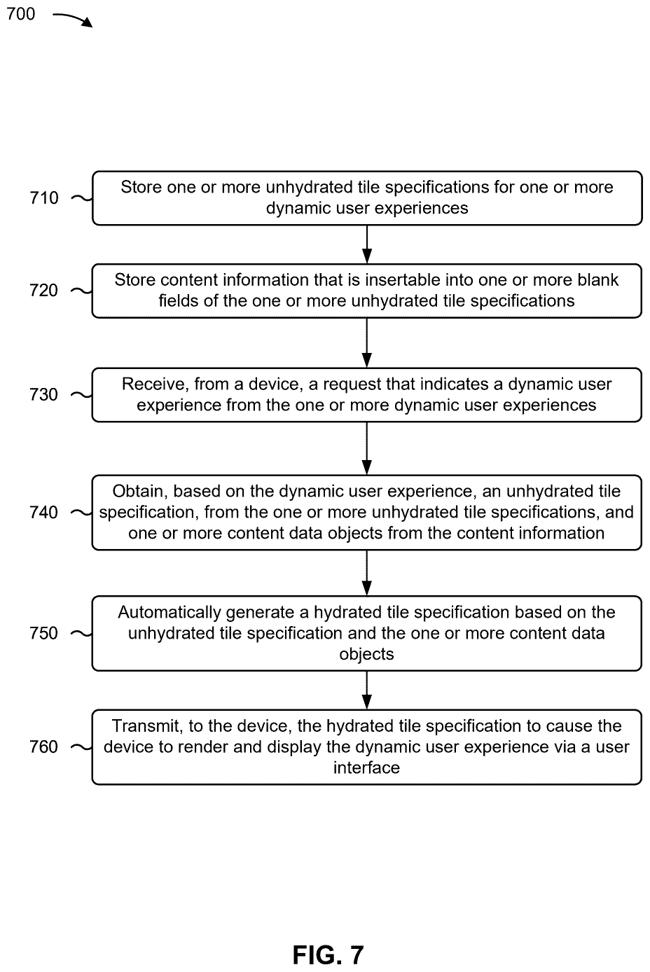

FIG. 7 is a flowchart of an example process 700 associated with integrated tile specification storage. In some implementations, one or more process blocks of FIG. 7 may be performed by a tile provider system (e.g., the tile provider system 405 or the tile provider system 510). In some implementations, one or more process blocks of FIG. 7 may be performed by another device or a group of devices separate from or including the tile provider system, such as a client device (e.g., the client device 410 or the client device 520), or one or more components of the tile provider system (e.g., the tile hub component 420, the tile provider component 425, the tile utility component 430, and/or the storage component 435). Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include storing one or more unhydrated tile specifications for one or more dynamic user experiences (block 710). For example, the tile provider system (e.g., using processor 620 and/or memory 630) may store one or more unhydrated tile specifications for one or more dynamic user experiences, as described above in connection with reference number 105 of FIG. 1A. As an example, the one or more unhydrated tile specifications may include the unhydrated tile specification 115 or the one or more unhydrated tile specifications 210. The tile provider system may store the one or more unhydrated tile specification in a storage component, such as the storage component 110, or the storage component 435.

As further shown in FIG. 7, process 700 may include storing content information that is insertable into one or more blank fields of the one or more unhydrated tile specifications (block 720). For example, the tile provider system (e.g., using processor 620 and/or memory 630) may store content information that is insertable into one or more blank fields of the one or more unhydrated tile specifications, as described above in connection with reference number 105 of FIG. 1A. As an example, the content information may include the content information 120 or the content information 215. The tile provider system may store the content information in the storage component, such as the storage component 110, or the storage component 435.

As further shown in FIG. 7, process 700 may include receiving, from a device, a request that indicates a dynamic user experience from the one or more dynamic user experiences (block 730). For example, the tile provider system (e.g., using processor 620, memory 630, input component 640, and/or communication component 660) may receive, from a device, a request that indicates a dynamic user experience from the one or more dynamic user experiences, as described above in connection with reference number 125 of FIG. 1B. As an example, the request may indicate an identifier of the dynamic user experience.

As further shown in FIG. 7, process 700 may include obtaining, based on the dynamic user experience, an unhydrated tile specification, from the one or more unhydrated tile specifications, and one or more content data objects from the content information (block 740). For example, the tile provider system (e.g., using processor 620 and/or memory 630) may obtain, based on the dynamic user experience, an unhydrated tile specification, from the one or more unhydrated tile specifications, and one or more content data objects from the content information, as described above in connection with reference number 130 of FIG. 1B. As an example, the tile provider system may obtain the unhydrated tile specification and the one or more content data objects from the storage component.

As further shown in FIG. 7, process 700 may include automatically generating a hydrated tile specification based on the unhydrated tile specification and the one or more content data objects (block 750). For example, the tile provider system (e.g., using processor 620 and/or memory 630) may automatically generate a hydrated tile specification based on the unhydrated tile specification and the one or more content data objects, as described above in connection with reference number 135 of FIG. 1B. As an example, the tile provider system may convert the unhydrated tile specification into the hydrated tile specification using the one or more content data objects (e.g., by inserting the one or more content data objects into respective fields of the unhydrated tile specification).

As further shown in FIG. 7, process 700 may include transmitting, to the device, the hydrated tile specification to cause the device to render and display the dynamic user experience via a user interface (block 760). For example, the tile provider system (e.g., using processor 620, memory 630, and/or communication component 660) may transmit, to the device, the hydrated tile specification to cause the device to render and display the dynamic user experience via a user interface, as described above in connection with reference number 140 of FIG. 1C. As an example, the hydrated tile specification may enable the device to extract user interface information to locally render one or more user interface tiles for the dynamic user experience.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1C, 2, and 3. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for integrated tile specification storage, the system comprising:
a storage component configured to:
store one or more unhydrated tile specifications for one or more dynamic user experiences; and
store one or more content key-value pairs that indicate data that is insertable into one or more blank fields of the one or more unhydrated tile specifications; and
a tile provider component configured to communicate with the storage component via an interface, wherein the tile provider component is configured to:
receive, from a device, a request that indicates a dynamic user experience from the one or more dynamic user experiences;
obtain, from the storage component and via the interface, an unhydrated tile specification from the one or more unhydrated tile specifications based on the dynamic user experience;
obtain, from the storage component and via the interface, at least one content key-value pair from the one or more content key-value pairs based on the request;
automatically generate a hydrated tile specification based on the unhydrated tile specification and the at least one content key-value pair, wherein the hydrated tile specification can be rendered by the device; and
transmit, to the device, the hydrated tile specification to cause the device to render and display the dynamic user experience via a user interface.

2. The system of claim 1, wherein the unhydrated tile specification includes at least one blank field in which dynamic data is to be populated, wherein the unhydrated tile specification cannot be rendered by the device due to the at least one blank field, and wherein the tile provider component, to automatically generate the hydrated tile specification, is configured to:
insert the at least one content key-value pair into the at least one blank field to generate the hydrated tile specification.

3. The system of claim 1, wherein the storage component is configured to:
store the one or more unhydrated tile specifications and the one or more content key-value pairs in a cloud storage bucket included in a cloud computing environment, wherein the tile provider component is configured to operate in the cloud computing environment.

4. The system of claim 1, wherein the storage component is configured to:
store the one or more unhydrated tile specifications and the one or more content key-value pairs in application code that is executable to cause the system to provide the one or more dynamic user experiences to the device; and
wherein the tile provider component is configured to:
execute the application code to obtain the unhydrated tile specification and the at least one content key-value pair.

5. The system of claim 4, wherein the one or more unhydrated tile specifications and the one or more content key-value pairs are bundled resources within the application code.

6. The system of claim 1, wherein the tile provider component is configured to:
provide remote access to the storage component to enable unhydrated tile specifications to be directly stored or modified.

7. The system of claim 1, wherein the unhydrated tile specification includes an identifier of the at least one content key-value pair, and wherein the tile provider component, to obtain the at least one content key-value pair, is configured to:
filter the one or more content key-value pairs stored in the storage component using the identifier of the at least one content key-value pair.

8. The system of claim 1, wherein the one or more blank fields are configured for dynamic data, wherein the request is for a prototype of the dynamic user experience, and wherein the tile provider component, to automatically generate the hydrated tile specification, is configured to:
insert the at least one content key-value pair into at least one blank field of the unhydrated tile specification to generate the hydrated tile specification, wherein the at least one content key-value pair includes prototype dynamic data for the dynamic user experience.

9. A method for integrated tile specification storage, comprising:
storing, by a system, one or more unhydrated tile specifications for one or more dynamic user experiences;
storing, by the system, content information that is insertable into one or more blank fields of the one or more unhydrated tile specifications;
receiving, by the system and from a device, a request that indicates a dynamic user experience from the one or more dynamic user experiences;
obtaining, by the system and based on the dynamic user experience, an unhydrated tile specification, from the one or more unhydrated tile specifications, and one or more content data objects from the content information;
automatically generating, by the system, a hydrated tile specification based on the unhydrated tile specification and the one or more content data objects; and
transmitting, by the system and to the device, the hydrated tile specification to cause the device to render and display the dynamic user experience via a user interface.

10. The method of claim 9, wherein the unhydrated tile specification includes at least one blank field in which dynamic data is to be populated, and wherein automatically generating the hydrated tile specification comprises:
inserting the one or more content data objects into the at least one blank field to generate the hydrated tile specification.

11. The method of claim 9, wherein the one or more unhydrated tile specifications and the content information are stored in a cloud storage bucket included in a cloud computing environment.

12. The method of claim 9, wherein the one or more unhydrated tile specifications and the content information are stored in application code that is executable to cause the system to provide the one or more dynamic user experiences to the device, and the method further comprising:
executing the application code to obtain the unhydrated tile specification and the one or more content data objects.

13. The method of claim 9, wherein the one or more unhydrated tile specifications and the content information are stored in a storage location, the method further comprising:
providing remote access to the storage location to enable unhydrated tile specifications to be directly stored or modified.

14. The method of claim 9, wherein the unhydrated tile specification includes an identifier of the one or more content data objects, and wherein obtaining the unhydrated tile specification and the one or more content data objects comprises:
filtering the content information using the identifier to identify the one or more content data objects.

15. The method of claim 9, wherein the one or more blank fields are configured for dynamic data, wherein the request is for a prototype of the dynamic user experience, and wherein automatically generating the hydrated tile specification comprises:
inserting the one or more content data objects into at least one blank field of the unhydrated tile specification to generate the hydrated tile specification, wherein the one or more content data objects includes prototype dynamic data for the dynamic user experience.

16. A system, comprising:
one or more memories; and
one or more processors, coupled to the one or more memories, configured to:
store one or more unhydrated tile specifications for one or more dynamic user experiences;
store content information that is insertable into one or more blank fields of the one or more unhydrated tile specifications;
receive, from a device, a request that indicates a dynamic user experience from the one or more dynamic user experiences;
obtain, based on the dynamic user experience, an unhydrated tile specification, from the one or more unhydrated tile specifications, and one or more content data objects from the content information;
automatically generate a hydrated tile specification based on the unhydrated tile specification and the one or more content data objects; and
transmit, to the device, the hydrated tile specification to cause the device to render and display the dynamic user experience via a user interface.

17. The system of claim 16, wherein the unhydrated tile specification includes at least one blank field in which dynamic data is to be populated, and wherein the one or more processors, to automatically generate the hydrated tile specification, are configured to:
insert the one or more content data objects into the at least one blank field to generate the hydrated tile specification.

18. The system of claim 16, wherein the one or more unhydrated tile specifications and the content information are stored in a cloud storage bucket included in a cloud computing environment.

19. The system of claim 16, wherein the one or more unhydrated tile specifications and the content information are stored in application code that is executable to cause the system to provide the one or more dynamic user experiences to the device.

20. The system of claim 16, wherein the unhydrated tile specification includes an identifier of the one or more content data objects, and wherein the one or more processors, to obtain the unhydrated tile specification and the one or more content data objects, are configured to:
filter the content information using the identifier to identify the one or more content data objects.
